(19) United States
(12) Patent Application Publication
(10) Pub. No.: US 2025/0001305 A1
(43) Pub. Date: Jan. 2, 2025

(54) SYSTEM AND METHOD FOR ADDING A NEW GAMING ENGINE TO A GAMING SERVICES PLATFORM

(71) Applicant: Playtika LTD, Herzeliya (IL)

(72) Inventors: Moshe SALHOV, Herzeliya (IL); Armand Nicolas Jean VALSESIA, Chavannes Renes (CH); Alistair Joseph DOSWALD, Carrouge VD (CH); Leonid RAICHMAN, Holon (IL); Noy BELGI, RaAnana (IL); Ilia MALANIN, Warsaw (PL); Andrey LISOVOY, Tel Aviv (IL); Yotam ROTHOLZ, Ramat HaSharon (IL); Aharon Zvi SHIFF, RaAnana (IL); Illia BIEZHENUSOV, Warszawa (PL); Oksana MOTRUK, Kharkiv (UA); Yuval MEY-TAL, Tel Aviv (IL)

(73) Assignee: Playtika LTD, Herzeliya (IL)

(21) Appl. No.: 18/755,792

(22) Filed: Jun. 27, 2024

Related U.S. Application Data
(60) Provisional application No. 63/523,949, filed on Jun. 29, 2023.
(60) Provisional application No. 63/617,779, filed on Jan. 5, 2024.
(60) Provisional application No. 63/617,791, filed on Jan. 5, 2024.
(60) Provisional application No. 63/623,862, filed on Jan. 23, 2024.
(60) Provisional application No. 63/555,941, filed on Feb. 21, 2024.
(60) Provisional application No. 63/638,957, filed on Apr. 26, 2024.

(51) Int. Cl. A63F 13/60; A63F 13/537

(52) U.S. Cl. CPC A63F 13/60; A63F 13/537

(57) ABSTRACT

There is provided a computer implemented method for adding a new gaming engine to a gaming services platform, comprising: identifying the new gaming engine to add to the gaming services platform, wherein the gaming services platform includes a plurality of other gaming engines operating thereon, initiating an integration process between the gaming services platform and the new gaming engine, the integration process including modifying at least one aspect of the new gaming engine to conform to a gaming services interface (GSI) of the gaming services platform for facilitating the integration, analyzing at least one metric associated with the new gaming engine using the GSI, and based on the analyzing, modifying at least one aspect of playing a game with the new gaming engine via the GSI, for improving the analyzed at least one metric.

### RELATED APPLICATIONS

This application claims the benefit of priority under 35 USC § 119 (e) of U.S. Provisional Patent Applications Nos. 63/523,949 filed on Jun. 29, 2023; 63/617,779 filed on Jan. 5, 2024; 63/617,791 filed on Jan. 5, 2024; 63/623,862 filed on Jan. 23, 2024; 63/555,941 filed on Feb. 21, 2024 and 63/638,957 filed on Apr. 26, 2024. The contents of the above applications are all incorporated by reference as if fully set forth herein in their entirety.

### BACKGROUND

The present invention, in some embodiments thereof, relates to gaming engines and, more specifically, but not exclusively, to systems and methods for integrating a new gaming engine with within a gaming services platform.

A game services platform is a software infrastructure or ecosystem designed to provide various services and features to gaming engines. The game services platform may offer a range of functionalities and/or tools for creating, deploying, and managing gaming engines more efficiently, as well as enhancing the gaming experience for players playing games run by gaming engines hosted by the gaming services platform.

### SUMMARY

According to a first aspect, a computer implemented method for adding a new gaming engine to a gaming services platform, comprising: identifying the new gaming engine to add to the gaming services platform, wherein the gaming services platform includes a plurality of other gaming engines operating thereon, initiating an integration process between the gaming services platform and the new gaming engine, the integration process including modifying at least one aspect of the new gaming engine to conform to a gaming services interface (GSI) of the gaming services platform for facilitating the integration, analyzing at least one metric associated with the new gaming engine using the GSI, and based on the analyzing, modifying at least one aspect of playing a game with the new gaming engine via the GSI, for improving the analyzed at least one metric.

According to a second aspect, a system for adding a new gaming engine to a gaming services platform, comprising: at least one processor executing a code for: identifying the new gaming engine to add to the gaming services platform, wherein the gaming services platform includes a plurality of other gaming engines operating thereon, initiating an integration process between the gaming services platform and the new gaming engine, the integration process including modifying at least one aspect of the new gaming engine to conform to a gaming services interface (GSI) of the gaming services platform for facilitating the integration, analyzing at least one metric associated with the new gaming engine using the GSI, and based on the analyzing, modifying at least one aspect of playing a game with the new gaming engine via the GSI, for improving the analyzed at least one metric.

According to a third aspect, a non-transitory medium storing program instructions for adding a new gaming engine to a gaming services platform, which when executed by at least one processor, cause the at least one processor to: identify the new gaming engine to add to the gaming services platform, wherein the gaming services platform includes a plurality of other gaming engines operating thereon, initiate an integration process between the gaming services platform and the new gaming engine, the integration process including modifying at least one aspect of the new gaming engine to conform to a gaming services interface (GSI) of the gaming services platform for facilitating the integration, analyze at least one metric associated with the new gaming engine using the GSI, and based on the analyzing, modify at least one aspect of playing a game with the new gaming engine via the GSI, for improving the analyzed at least one metric.

In a further implementation form of the first, second, and third aspects, the plurality of other gaming engines are designed for supporting and/or for optimal performance of different types of games, and the new gaming engine is identified according to being designed for supporting and/or being designed for optimal performance of a type of game not currently supported and/or not currently optimized for execution by any of the plurality of other gaming engines hosted by the gaming services platform.

In a further implementation form of the first, second, and third aspects, the different type of games include one or more of: 2D versus 3D, single player versus multi-player, fast graphic rendition, and type of client terminal on which game is being played.

In a further implementation form of the first, second, and third aspects, the at least one metric is for measuring the performance of and/or user satisfaction in conjunction with, the new gaming engine running the type of game not currently supported and/or not currently optimized for execution by any of the plurality of other gaming engines hosted by the gaming services platform.

In a further implementation form of the first, second, and third aspects, the plurality of other gaming engines and the new gaming engine added to the gaming services platform are operated and/or accessed via a common GSI of the gaming services platform.

In a further implementation form of the first, second, and third aspects, each one of the plurality of other gaming engines and the new gaming engine added to the gaming services platform is associated with a respective instance of the GSI.

In a further implementation form of the first, second, and third aspects, the plurality of other gaming engines and the new gaming engine are hosted by an external computing environment that is different than a computing platform hosting the gaming services platform.

In a further implementation form of the first, second, and third aspects, each one of the plurality of other gaming engines and the new gaming engine uses its respective instance of the GSI for communicating with a service engine, for being accessed and/or controlled and/or managed by the service engine.

In a further implementation form of the first, second, and third aspects, the integration process comprises: obtaining a source code operative to implement the new gaming engine, applying a machine learning (ML) model to the source code, wherein the ML model is pre-trained to identify at least one region in the source code to be modified to conform to the GSI, and receiving, from the ML model, at least a suggestion indicating modification of the at least one region of the source code to conform to the GSI.

In a further implementation form of the first, second, and third aspects, applying comprises applying the ML model to the source code in combination with at least one aspect of the new gaming engine for modification to conform to the GSI, wherein the suggestion indicates modification of the at least one aspect of the source code of the new gaming engine to conform to the GSI.

In a further implementation form of the first, second, and third aspects, the at least the suggestion comprises automatically modifying the at least one region of the source code and compiling the source code including the modifications to create an executable version of the new gaming engine for adding to the gaming services platform.

In a further implementation form of the first, second, and third aspects, the ML model is trained on a training dataset of a plurality of records, wherein a record includes a sample source code of a sample gaming engine and sample at least one aspect, and a ground truth indicating at least one recommendation for adapting the at least one aspect of the sample source code to conform to the GSI.

In a further implementation form of the first, second, and third aspects, the at least one aspect of the new gaming engine is modified to conform to the GSI.

In a further implementation form of the first, second, and third aspects, the at least one aspect being modified to conform to the GSI is selected from: input handling from different user interface devices supported by the GSI, meeting rendering standard supported by the GSI, meeting a physics simulation supported by the GSI, meeting audio capabilities supported by the GSI, enabling multiplayer features supported by the GSI, meeting user interface (UI) features supported by the GSI, script supported by the GSI, meeting resources supported by the GSI, performance requirements supported by the GSI, and compatibility with different end user devices supported by the GSI, and providing a data interface for relaying gaming data information from the new gaming engine for analysis by the service engine via the GSI of the gaming services platform.

In a further implementation form of the first, second, and third aspects, analyzing comprises predicting a target set of configuration parameters, that when the at least one aspect of playing the game is modified to the target set of configuration parameters, the target set of configuration parameters improves the at least one metric.

In a further implementation form of the first, second, and third aspects, the predicting is performed by a simulation engine for simulating implementation of a modified at least one aspect on playing the game for predicting an effect on the at least one metric.

In a further implementation form of the first, second, and third aspects, the predicting is performed by a ML model trained to predict an effect on at least one metric in response to an input of a modified at least one aspect.

In a further implementation form of the first, second, and third aspects, the at least one metric is for measuring a user achievement requirement denoting goals and/or milestones for the player to accomplish within a type of game for which the new gaming engine is designed to support and/or designed for optimal performance.

In a further implementation form of the first, second, and third aspects, the target set of configuration parameters comprises a combination of a first type of configuration parameters and a second type of configuration parameters, the first type of configuration parameters being associated with setting an effort level predicted to be tolerated by the player, and the second type of configuration parameters associated with setting a reward level predicted as an incentive by the player.

In a further implementation form of the first, second, and third aspects, the new gaming engine to be added to the gaming service platform is identified according to ability to run a candidate gaming scenario meeting a target, wherein the candidate gaming scenario is associated with at least one desired outcome of users interacting with the gaming engine implementing the candidate gaming scenario.

In a further implementation form of the first, second, and third aspects, further comprising: identifying, in the new gaming engine, a sub-set of the users interacting with the gaming engine for analyzing the candidate gaming scenario implemented by the new gaming engine, virtually implementing the candidate gaming scenario by the new gaming engine for interaction by the users as if the candidate gaming scenario is not virtually implemented, collecting data on the sub-set of users identified, in conjunction with the users interacting with the gaming engine virtually implementing the candidate gaming scenario, computing at least one game related result predicted to occur when the new gaming scenario is explicitly implemented by the candidate gaming engine using the data collected for the virtually implemented candidate gaming engine scenario, and in response to the at least one game related scenario meeting a target, identifying the new gaming engine to be added to the gaming services platform for running the candidate gaming scenario for interaction by the users.

In a further implementation form of the first, second, and third aspects, analyzing at least one metric and modifying at least one aspect of playing the game with the new gaming engine via the GSI, for improving the analyzed at least one metric, comprises: accessing a candidate gaming scenario to be implemented in the new gaming engine and in conjunction with users interacting with the gaming engine implementing the candidate gaming scenario, wherein the candidate gaming scenario is associated with at least one desired outcome of users interacting with the gaming engine implementing the candidate gaming scenario, identifying a sub-set of the users interacting with the new gaming engine for analyzing the candidate gaming scenario implemented by the new gaming engine, virtually implementing the candidate gaming scenario by the new gaming engine for interaction by the users as if the candidate gaming scenario is not virtually implemented, collecting data on the sub-set of users identified in conjunction with the users interacting with the new gaming engine virtually implementing the candidate gaming scenario, computing at least one game related result predicted to occur when the candidate gaming engine is explicitly implemented by the new gaming engine using the data collected for the virtually implemented candidate gaming engine scenario, and wherein modifying at least one aspect comprises: in response to the at least one game related scenario meeting a target, explicitly implementing the candidate gaming scenario in the new gaming engine for interaction by the users.

In a further implementation form of the first, second, and third aspects, the at least one metric associated with the new gaming engine comprises a plurality of behavior parameters relating to in-game actions of a plurality of players using a plurality of client devices engaged in a game running on the new gaming engine, wherein analyzing comprises balancing between a user experience of at least one of the plurality of players and at least one long-term factor of the game running on the new gaming engine by generating, based on the plurality of behavior parameters, at least one reward recommendation for allocating at least one reward to at least one of the plurality of players for at least one in-game action made by the at least one player, wherein modifying at least one aspect comprises causing the gaming engine to adjust a graphic user interface (GUI) of the client device of at least one of the plurality of players to reflect the at least one allocated reward.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for adding a new gaming engine to a gaming services platform, in accordance with some embodiments of the present invention; and

FIG. 2 is a flowchart of a method of adding a new gaming engine to a gaming services platform, in accordance with some embodiments of the present invention.

### DETAILED DESCRIPTION

The present invention, in some embodiments thereof, relates to gaming engines and, more specifically, but not exclusively, to systems and methods for integrating a new gaming engine with within a gaming services platform.

As used herein, the term gaming engine and game engine are interchangeable.

As used herein, the term new gaming engine refers to a gaming engine which is not initially part of the gaming services platform, and is being integrated into the gaming services according to least one embodiment described herein.

An aspect of some embodiments of the present invention relates to systems, methods, computing devices, and/or code instructions (stored on a data storage device and executable by one or more processors) for integrating a new gaming engine to a gaming services platform that may be hosting multiple other gaming engines. The gaming services platform may virtually host gaming engines, which may reside on a computing environment (e.g., hardware device) that is different than the computing platform (e.g., hardware device) running the gaming services platform. The new gaming engine may be automatically identified and/or automatically integrated to the gaming services platform. The new gaming engine may be identified according to being designed for supporting and/or for optimal performance of a type of game not currently supported and/or not currently optimized for execution by any of the other gaming engines hosted by the gaming services platform. An integration process may be initiated between the gaming services platform and the gaming engine. The integration process may include the feature of modifying one or more aspects of the gaming engine to conform to a gaming services interface (GSI) of the gaming services platform for facilitating the integration. The GSI may be implemented as a centralized and/or common interface for communication of data between the multiple gaming engines hosted by the gaming services platform and a service engine (and/or other external component). Alternatively, each gaming engine is associated with a respective instance of the GSI. The GSI may be used, for example, for managing and/or accessing and/or operating of the respective gaming engine by the service engine. The multiple gaming engines may be virtually hosted by the gaming services platform (e.g., hosted on an external computing environment that is different than the computing platform hosting the gaming services platform), where each gaming engine uses its corresponding instance of the GSI to communicate with the service engine. One or more metrics associated with the new gaming engine may be analyzed using the GSI, for example, using the GSI for relaying gaming data from the multiple gaming engines to the service engine for analysis. Examples of metrics include measuring the performance the new gaming engine running a game, user satisfaction of players playing the game running on the new gaming engine, and/or a user achievement requirement denoting goals and/or milestones for a player to accomplish. Based on the analysis, one or more aspects of playing a game with the gaming engine via the GSI may be modified. Examples of aspects include setting configuration parameters of the new gaming engine, supporting multiplayer features, and allocation of computational resources to the new gaming engine. The modification may be performed for improving the analyzed metric(s).

At least some embodiments described herein address the technical problem of improving the process of adding (e.g., integrating) a new gaming engine to a gaming services platform that includes multiple other gaming engines operating thereon. At least some embodiments described herein improve the technology of integration tools, in particular for adding a new gaming engine to a gaming services platform that includes multiple other gaming engines operating thereon. At least some embodiments described herein improve upon prior approaches for adding a new gaming engine to a gaming services platform that includes multiple other gaming engines operating thereon.

Different gaming engines may be designed and/or optimized for different types of games. For example, one gaming engine may be designed for individual play, while a different gaming engine may be designed for multi-player interactions. Under existing approaches, a developer needs to carefully select the correct gaming engine that they expect will provide the best performance and/or best experience for a game they are developing. An incorrect selection of the gaming engine may be difficult to correct, since switching a different gaming engine is complex and/or technically challenging. Selection of the gaming engine and/or evaluation of the best gaming engine is traditionally done manually by the developer.

At least some embodiments described herein address the aforementioned technical problem, and/or improve the aforementioned technical field, and/or improve the aforementioned technical field by providing a gaming services platform that hosts multiple different gaming engines, which may be optimized for different types of games. New gaming engines may be automatically added to the gaming engine platform, by initiating an integration process. Each new gaming engine may be modified to conform to a gaming services interface (GSI) of the gaming services platform. The gaming engines hosted by the gaming services platform may be accessed and/or operated by a common GSI. Alternatively or additionally, each gaming engine is associated with its own respective instance of the GSI. The GSI enables users (e.g., managers and/or operators) to learn how to interact with the GSI once, which then enables the users (e.g., managers and/or operators) to access and/or operate the different gaming engines hosted by the gaming services platform. This is in contrast to traditional approaches where the manager and/or operator is required to learn how to interact with the specific interface of each gaming engine, which is technically complex, prone to error, and/or time consuming. Moreover, one or more metrics associated with the new gaming engine being added to the gaming services platform may be analyzed via the GSI. The GSI may be implemented as a centralized and/or common interface and/or common instance of an interface, for communication of data between the multiple gaming engines hosted by the gaming services platform and a service engine (and/or other external component), for example, for access and/or operation of the gaming engines by the service engine. The GSI may be used for relaying gaming data from the multiple gaming engines to the service engine for analysis. This is in contrast to traditional approaches where each of the multiple gaming engines may be independently configured to communicate with a service engine, such as using different communication channels and/or protocols, which is complex, time consuming, and/or prone to error. The metric(s) may be improved according to the analysis, by using the GSI to modify one or more aspects of playing the game. The GSI may be used to analyze and/or modify aspects of playing different games run by different gaming engines of the gaming services platform.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

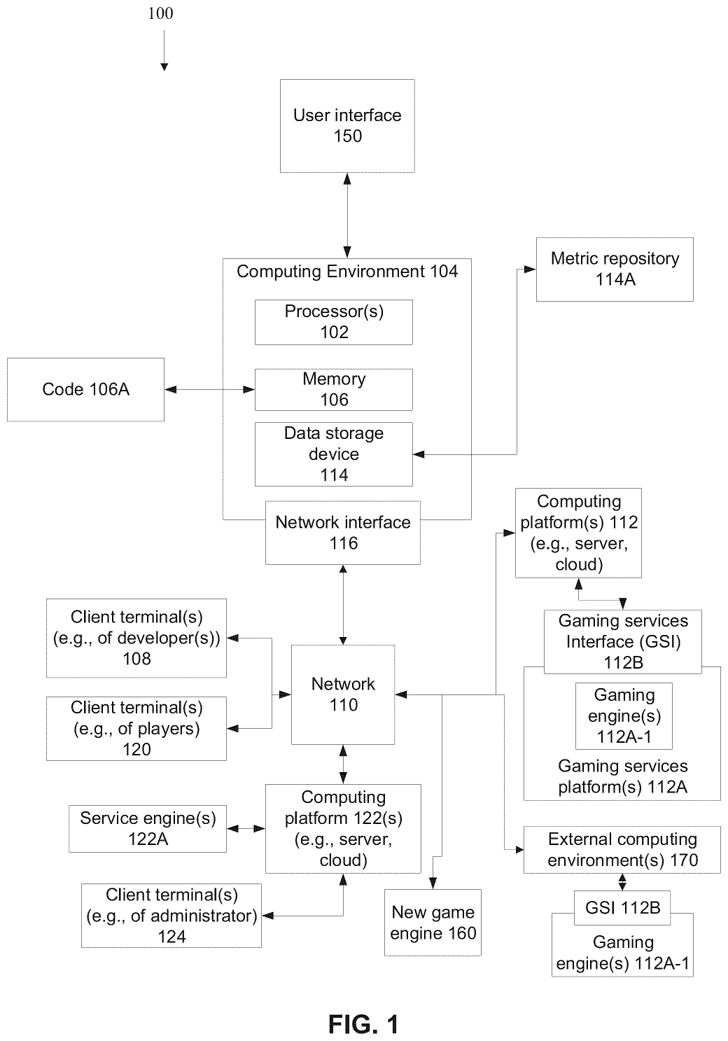

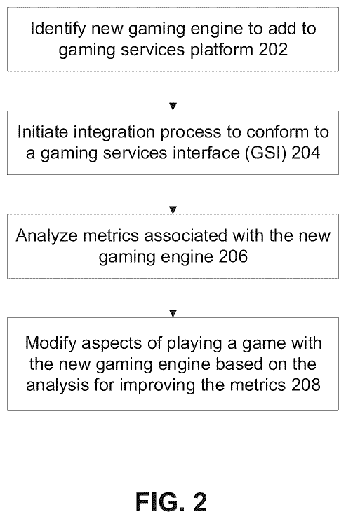

Reference is now made to FIG. 1, which is a block diagram of components of a system 100 for adding a new gaming engine to a gaming services platform, in accordance with some embodiments of the present invention. Reference is also made to FIG. 2, which is a flowchart of a method of adding a new gaming engine to a gaming services platform, in accordance with some embodiments of the present invention.

System 100 may implement the acts of the method described with reference to FIG. 2 by processor(s) 102 of a computing environment 104 executing code instructions 106A stored in a memory 106.

Computing environment 104 may be implemented as, and/or may be included in service engine 122A and/or other components described herein, for example one or more and/or combination of: an administrative server, a computing cloud, a group of connected devices, a server, a virtual server, a client terminal, a virtual machine, a desktop computer, a thin client, a network node, and/or a mobile device (e.g., a Smartphone, a Tablet computer, a laptop computer, a wearable computer, glasses computer, and a watch computer).

Computing environment 104 may add a new gaming engine 160 to a gaming services platform 112A which may host multiple other gaming engine(s) 112-A, as described herein.

Gaming services platform 112A may be hosted by a computing platform 112, for example, a server and/or computing cloud. Gaming services platform 112A may be designed for operating multiple different gaming engines 112A-1. Gaming engine(s) 112A-1 may be designed for interactions, optionally simultaneously, by multiple players, optionally using respective client terminals 120 via a network 110.

Gaming services platform 112A may include a gaming services interface (GSI) 112B. GSI 112B may be implemented as a virtual interface, for example, an application programming interface (API), software development kit (SDK), and the like. GSI 112B may provide a single common interface and/or different instances of the common interface, for monitoring and/or adapting one or more gaming engines 112A-1 hosted by gaming services platform 112A, for example, by client terminals 108 of developers and/or by service engine 112A and/or other devices. GSI 112B may be used for relaying gaming data information from new gaming engine 160 and/or other gaming engines 112A-1 hosted by gaming services platform 112A for analysis by a service engine 122A (and/or another external device).

Gaming engine(s) 112A-1 may be virtually hosted by gaming services platform 112A. The gaming services platform 112A may represent a logical architecture. Respective gaming engines 112A-1 and associated GSI 112B may be hosted by external computing environment 170 that may be distinct from computing platform 112 that hosts gaming services platform 112A. External computing environment 170 may be a different physical device than computing platform 112 (e.g., server, computing cloud) and/or may be a different virtual machine and/or virtual server than computing platform 112 (e.g., run on the same underlying hardware). Each gaming engine 112A-1 may be associated with its own instance of GSI 112B, for example, GSI 112B is run by gaming engine 112A-1, included in the code of gaming engine 112A-1, and/or GSI 112B is run by external computing environment 170 that hosts gaming engine 112A-1. Different gaming engines 112A-1 run by different external computing environments 170 may use their respective GSI 112B for communicating with a common gaming services platform 112A hosted by computing platform 112. The GSI 112B associated with each respective gaming engine 112A-1 virtually hosted by the gaming services platform 112A enables each respective gaming engine 112A-1 to be accessed and/or controlled and/or managed by service engine(s) 122A.

In this manner, users may virtually connect their different gaming engines to the gaming services platform by installing the GSI, without necessarily requiring changing the hosting hardware and/or hosting software, such a without moving their gaming engines to the computing platform hosting the gaming services platform and/or without installing the gaming engines within the gaming services platform.

Alternatively or additionally, gaming engine(s) 112A-1 may be physically hosted by gaming services platform 112A and/or by computing platform 112 that is hosting gaming services platform 112A. The gaming engine(s) 112A-1 may be installed within gaming services platform 112A and/or installed on the same computing platform 112 that is running gaming engine 112A-1. Gaming engine 112A-1 and/or computing platform 112 may host one or multiple gaming engines 112A-1. Each gaming engine 112A-1 may be associated with its own GSI 112B. Alternatively, multiple gaming engines 112A-1 hosted by gaming services platform 112A and/or computing platform 112 may be associated with a common GSI 112B. The GSI 112B associated with gaming engine(s) 112A-1 enables gaming engine(s) 112A-1 to be accessed and/or controlled and/or managed by service engine(s) 122A.

Service engine 122A may be hosted by a computing platform 122, for example, a server and/or computing cloud. Service engine 122A may monitor and/or adapt gaming services platform(s) 112A, such as for monitoring and/or adapting gaming engines 112A-1 running on gaming services platform(s) 112A. Optionally, more client terminals 124 (e.g., of administrative user(s)) present data obtained by the monitoring and/or enable the administrative user to adapt the gaming services platform 112A and/or the gaming engines 112A-1, for example, presented on a display thereof. The user(s) of client terminal(s) 124 may monitor player interactions by observing and/or analyzing the data obtained by the monitoring, and optionally consequently make decisions.

Computing platform 122 running service engine 122A may be different than computing platform 112 running gaming services platform(s) 112A.

Multiple architectures of system 100 based on computing device 104 may be implemented. For example:
Computing environment 104 may be separate from computing platform 122 and/or from computing platform 112.
Computing environment 104 is operated by, running on, and/or integrated with computing platform 122.
Computing environment 104 is operated by, running on, and/or integrated with computing platform 112.
Computing environment 104 is operated by, running on, and/or integrated with gaming services platform 112A.
Computing environment 104 may centrally add (and/or centrally generate instructions to add) new gaming engine 160 to gaming services platform 112A, as described herein.

Computing environment 104 may provide the service of adding new gaming engine 160 to gaming services platform(s) 112A to one or more client terminal(s) (e.g., of developers) and/or to other component, for example by: providing software as a service (SaaS), providing software services accessible using a software interface (e.g., application programming interface (API), software development kit (SDK)), providing an application for local download, providing an add-on to a web browser running on the client terminal(s) 108 and/or components, and/or providing functions using a remote access session, such as through a web browser accessing a web site hosted by computing environment 104.

Processor(s) 102 of computing environment 104 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described with reference to FIG. 2 when executed by processor(s) 102.

Computing environment 104 may include a data storage device 114 for storing data, for example, a metric repository 114A which may be designed to store different metrics computed for new gaming engine 160 being added to gaming services platform 112A. Data storage device 114 may be implemented as, for example, a memory, a local hard-drive, virtual storage, a removable storage unit, an optical disk, a storage device, and/or as a remote server and/or computing cloud (e.g., accessed using a network connection). It is noted that code stored on data storage device 114 may be loaded into memory 106 for execution by processor(s) 102.

Network 110 may be implemented as, for example, the internet, a local area network, a virtual network, a wireless network, a cellular network, a local bus, a point to point link (e.g., wired), and/or combinations of the aforementioned.

Computing environment 104 may include a network interface 116 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Computing device 104 (and/or other components such as client terminals 108, 120, 124) includes and/or is in communication with one or more physical user interfaces 150 that include a mechanism for a user to enter data (e.g., make manual modification to the new gaming engine 160) and/or view data (e.g., view data regarding the automated adding of the new gaming engine 160). Exemplary user interfaces 150 include, for example, one or more of, a touchscreen, a display, a virtual reality display (e.g., headset), gesture activation devices, a keyboard, a mouse, and voice activated software using speakers and microphone.

Referring now back to FIG. 2, at 202, a new gaming engine to add to the gaming services platform is identified. The identification may be performed, for example, by a user indicating the new gaming engine to be added, and/or by code that automatically analyzes gaming engines that are not currently operating on the gaming services platform.

The gaming services platform may include multiple other gaming engines operating thereon. The other gaming engines may be designed for supporting and/or for optimal performance of different types of games.

The new gaming engine may be identified according to being designed for supporting and/or being designed for optimal performance of a type of game not currently supported and/or not currently optimized for by any of the other gaming engines. Examples of features that the new gaming engine may add to the gaming services platform over existing gaming engines hosted by the existing gaming services platform include:

2D vs. 3D: Some gaming engines are specifically designed for 2D game development, focusing on features like sprite-based animations and tilemap support. Other gaming engines are geared towards 3D game development with advanced rendering, physics, and animation systems.

Single Player versus Multi-player: Some gaming engines are specifically designed for a single player, while other gaming engines may be designed for multi-player, optionally simultaneously. For example, single player gaming engines may be designed to support games such as car racing, and fights with avatars. Multi-player gaming engines may be designed to support games such as quests in which multiple players are simultaneously interacting in a virtual environment, by providing features to enable interactions between the players, such as ability to send text messages to other players, receive messages from other players, trade virtual objects with other players, and/or cooperate with other players in obtaining a game objective.

General-purpose vs. Specialized Engines: General-purpose gaming engines are versatile and may be used to create a wide range of game genres and types. Specialized gaming engines may target specific genres or platforms, such as for role-playing games or for visual novels.

Programming Languages and Scripting: Gaming engines may support different programming languages or scripting languages for game logic and behavior. For example, some gaming engines primarily use C #, while other gaming engines use C++ and its Blueprint visual scripting system.

Platform Support, such as type of client terminal on which the game is being played: Some gaming engines support multiple platforms, including PC, consoles, mobile devices, and VR/AR devices. Other gaming engines may be more limited in platform support, focusing on specific platforms or operating systems.

Learning Curve and Accessibility: The learning curve can vary between gaming engines, with some offering more beginner-friendly interfaces and tutorials (e.g., Unity's beginner tutorials) and others requiring more technical expertise.

Community and Support: Community size and support resources (forums, documentation, tutorials) can vary between gaming engines, impacting the availability of help and resources for developers.

Graphics and Rendering Capabilities: Differences in rendering pipelines, lighting systems, and post-processing effects can affect the visual quality and performance of games developed with different gaming engines. For example, some gaming engines may be designed for fast graphic rendition.

Asset Store and Marketplace: Some gaming engines have integrated asset stores or marketplaces where developers can purchase or download assets, plugins, and tools to enhance their projects.

Ecosystem and Integrations: Different gaming engines may support different ecosystems and/or integrations, including support for third-party tools, middleware, and plugins (e.g., audio middleware, analytics, version control).

Optionally, the new gaming engine to be added to the gaming service platform is identified according to ability to run a candidate gaming scenario meeting a target. This may provide a way for the service engine to analyze and/or affect gaming engines already ingested by the gaming services platform. The candidate gaming scenario may be associated with one or more desired outcomes of users interacting with the gaming engine implementing the candidate gaming scenario. Examples of candidate gaming scenarios include: replacement of an existing reward calculation with an adapted reward calculation for allocation of rewards, a time challenge scenario, and an in-game objective scenario. The following exemplary process may be used to identify such new gaming engines: A sub-set of the users interacting with the new gaming engine (optionally interacting with the game run by the new gaming engine) is identified. The sub-set of users may be identified for analyzing the candidate gaming scenario implemented by the new gaming engine (optionally implemented by the game run by the new gaming engine). The candidate gaming scenario may be virtually implemented by the new gaming engine (or by the game run by the new gaming engine) for interaction by the users as if the candidate gaming scenario is not virtually implemented. The users are unaware of the virtual implementation during their interaction with the new gaming engine. Data on the sub-set of users is collected. The data may be collected while the sub-set of users is interacting, optionally along with other users, with the gaming engine virtually implementing the candidate gaming scenario. One or more game related results predicted to occur when the new gaming scenario is explicitly implemented by the candidate gaming engine are computed. Examples of game related results include: amount of rewards users have collected using the virtually implemented reward allocation, whether users met or did not meet a time challenge, and the like. The game related result(s) are computed using the data collected for the virtually implemented candidate gaming engine scenario. In response to the game related results of the candidate gaming scenario meeting a target, the new gaming engine may be identified for being added to the gaming services platform. The new gaming scenario may be added based on the ability to run the candidate gaming scenario for interaction by the users, based on the prediction that the target will be met.

Additional exemplary details of evaluating a candidate gaming scenario are described, for example, with reference to U.S. Provisional Patent Application No. 63/555,941 “ADAPTING GAMING SCENARIOS OF A GAME ENGINE” filed on Feb. 21, 2024, incorporated herein by reference in its entirety.

At 204, an integration process may be initiated between the gaming services platform and the new gaming engine. The integration process may include modifying one or more aspects of the new gaming engine to conform to a gaming services interface (GSI) of the gaming services platform for facilitating the integration.

The gaming engine is an execution platform for running a game. When the game is being executed by the gaming engine, data elements may be conveyed from the gaming engine to the service engine while the game is being played. The data elements may be conveyed via a communication network running via the GSI between a server running the gaming services platform hosting the gaming engine and another server running the service engine. The gaming engines hosted by the gaming services platform may be designed to interact with multiple players. The multiple players use multiple client terminals interacting with the gaming engines hosted by the gaming services platform over a network via the GSI.

The GSI may provide a common interface for operating and/or accessing the multiple different gaming engines hosted by the gaming services platform. The GSI may allow a developer to learn the GSI once, and then use the common GSI to operate and/or access the multiple different gaming engines.

The GSI may provide a common interface for relaying gaming data information for analysis from each respective gaming engine hosted by the gaming services platform, to a single and/or common service engine.

Alternatively or additionally, each respective gaming engine may use a respective instance of the GSI associated with and/or installed on the respective gaming engine, for communicating with the service engine. The different gaming engines may be virtually hosted by the gaming service platform, such as the different gaming engines may be installed on hardware that is different than the gaming services platform, for example, on external computing environments.

The service engine may analyze the data from the multiple gaming engines running and/or virtually hosted by the gaming services platform, for example, presenting the data on a display such as to allow a user to analyze the data, determining whether each gaming engine is running into performance problems and/or errors, determining interactions of users with respective games run by the different gaming engines, and the like.

The GSI may comply with a common standard data format. The different gaming engines may be configured according to the common standard data format, which may enable easy integration between the different gaming engines and the service engine, and/or may enable the different gaming engines to communicate between each other. For example, assets earned by a user playing one game on one engine may be accessed by the same user playing a different game on a different engine.

The GSI may be implemented as a virtual interface, for example, an application programming interface (API), a software development kit (SDK), and the like.

An exemplary integration process is now described: a source code operative to implement the new gaming engine is obtained. A machine learning (ML) model may be applied to the source code of the new gaming engine. Alternatively, the ML model is applied to the source code of the new gaming engine in combination with one or more aspects of the new gaming engine. The aspects may be for modification to conform to the GSI. The ML model may be pre-trained to identify one or more regions in the source code to be modified, optionally to conform to the GSI. At least a suggestion indicating modification of the region(s) of the source code to modify, optionally conform to the GSI, is obtained from the ML model. Alternatively or additionally, the suggestion indicates modification of the aspect(s) of the source code of the new gaming engine, optionally to conform to the GSI. Alternatively to the suggestion, or in addition to the suggestion, the region(s) of the source code may be automatically modified. The automatic modification may be done by the ML model, and/or by another executing process according to the generated suggestion. The source code including the modifications may be automatically compiled to create an executable version of the new gaming engine for adding to the gaming services platform.

The ML model may be pre-trained on a training dataset of multiple records. A record may include a sample source code of a sample gaming engine and optionally one or more sample aspects. The record may further include a ground truth indicating one or more recommendations for adapting the sample source code, optionally to conform to the GSI, optionally for adapting the aspect(s) of the sample source code.

Additional exemplary details with respect to integration of a gaming engine and/or aspects, are described for example, with reference to U.S. Provisional Patent Application No. 63/617,779 “INTEGRATION OF A GAME ENGINE WITH A SERVICE ENGINE” filed on Jan. 5, 2024, and/or U.S. Provisional Patent Application No. 63/617,791 “MACHINE LEARNING MODEL FOR INTEGRATION OF A GAME ENGINE WITH A SERVICE ENGINE” filed on Jan. 5, 2024, incorporated herein by reference in their entirety.

Examples of aspects of the new gaming engine to be modified, optionally to conform to the GSI, include:
Providing a data interface for relaying gaming data information from the new gaming engine for analysis by the service engine, optionally via the GSI of the gaming services platform: For example, modifying the source code of the new gaming engine to comply with a communication protocol and/or data structure format, optionally defined by the GSI.
Input handling from different user interface devices, optionally supported by the GSI: For example, Adjusting how the gaming engine handles input from different devices (keyboard, mouse, gamepad, touch screen), optionally to comply with the GSI's input requirements. Mapping input events to specific actions or command, optionally as defined by the GSI.
Meeting rendering standard, optionally supported by the GSI: For example, modifying the rendering pipeline to support custom rendering techniques or visual effects, optionally specified by the GSI. Integrating external rendering libraries or frameworks, optionally to meet the GSI's rendering standards.
Meeting a physics simulation, optionally supported by the GSI: For example, customizing the physics simulation, optionally to match the GSI's requirements for object interactions, collisions, and dynamics. Implementing additional physics constraints or behaviors not natively supported by the new gaming engine.
Meeting audio capabilities, optionally supported by the GSI: For example, adapting the audio management system to handle audio cues, events, and spatialization, optionally according to the GSI's specifications. Integrating third-party audio middleware or plugins to enhance audio capabilities as needed.
Enabling multiplayer features, optionally supported by the GSI: For example, extending the networking functionality, optionally to support the GSI's multiplayer features, such as synchronization, latency compensation, and session management. Implementing custom network protocols or optimizations to improve performance and reliability in multiplayer scenarios.
Meeting user interface (UI) features, optionally supported by the GSI: For example, customizing the user interface system to design and implement UI elements, optionally consistent with the GSI's visual style and interaction patterns. Integrating UI animations, transitions, and responsiveness, optionally as required by the GSI.
Script optionally supported by the GSI, meeting resources optionally supported by the GSI: For example, modifying or extending the scripting system to implement gameplay mechanics, rules, and logic optionally specified by the GSI. Integrating external scripting languages or frameworks to support custom gameplay scripting as needed.
Asset Management: For example, enhancing the asset management system to handle resources (textures, models, animations) optionally in accordance with the GSI's asset requirements and formats. Implementing asset streaming or loading optimizations to improve performance and memory usage.
Performance requirements, optionally supported by the GSI: For example, optimizing the engine's performance, optionally to meet the GSI's requirements, for frame rate, responsiveness, and scalability. Profiling and debugging the engine to identify and resolve performance bottlenecks, optionally specific to the GSI's use cases.
Compatibility with different end user devices, optionally supported by the GSI: For example, ensuring that the new gaming engine's codebase is compatible with the target platforms, optionally specified by the GSI (e.g., PC, consoles, mobile devices) and making necessary adjustments for portability and optimization.

At 206, one or more metrics associated with the new gaming engine are analyzed using the GSI. The metrics may be analyzed based on data sent from the new gaming engine over the GSI, and/or based on data accessed from the new gaming engine via the GSI. The analysis may be performed by the service engine, which receives the metrics and/or the data for computing the metrics from the new gaming engine over the GSI.

The metric(s) may provide a comprehensive overview of the new gaming engine's performance and/or may help developers identify areas for optimization and/or improvement to deliver a smoother and more enjoyable gaming experience.

The metric(s) may be for measuring the performance of the new gaming engine, optionally executing a type of game not currently supported and/or not currently optimized for execution by any of the plurality of other gaming engines hosted by the gaming services platform. Examples of metrics for measuring performance of the new gaming engine include:
Frames Per Second (FPS): FPS measures the number of frames rendered per second. A higher FPS typically indicates smoother gameplay. Lower FPS can result in stuttering and reduced player experience.
Frame Time: Frame time measures the time taken to render each frame. It's the reciprocal of FPS and provides more granular insight into the performance. Smaller frame times indicate better performance.
CPU Usage: Monitoring CPU usage provides insight into how much processing power the gaming engine is consuming. High CPU usage can lead to performance bottlenecks, especially in CPU-bound games.
GPU Usage: GPU usage indicates how much of the graphics processing unit's capacity is being utilized. High GPU usage may suggests that the gaming engine is rendering complex graphics, while low GPU usage may indicate optimization opportunities.
Memory Usage: Monitoring memory usage may help identify memory leaks and/or excessive memory consumption, which can degrade performance or lead to crashes over time.
Network Latency: In multiplayer games, network latency measures the delay between sending a message from one player's device to another player's device. High latency may result in laggy gameplay and synchronization issues.
Loading Times: Loading times measure how long it takes to load game assets, levels, or scenes. Long loading times may disrupt the player experience and may be minimized.
Input Latency: Input latency measures the delay between the player's input (e.g., pressing a button) and the game's response. Lower input latency may leads to more responsive controls and better gameplay experience.
Power Consumption: Monitoring power consumption may be significant for mobile or battery-powered devices. High power consumption can drain the battery quickly and negatively impact user experience.
Render Pipeline Metrics: Analyzing render pipeline metrics such as draw calls, triangles rendered, and shader complexity may provide insights into the graphical workload of the gaming engine.
Physics Performance: For games with complex physics simulations, monitoring physics performance metrics like collision detection time and rigid body simulation time can help optimize performance.
Al Performance: In games with AI-driven NPCs or entities, measuring AI performance metrics such as decision-making time and pathfinding performance can identify bottlenecks in AI processing.

Alternatively or additionally, the metric(s) may be for measuring user satisfaction in conjunction with the new gaming engine running a game, optionally running the type of game not currently supported and/or not currently optimized for execution by any of the plurality of other gaming engines hosted by the gaming services platform. Measuring user satisfaction of a game running on the new gaming engine may be used for understanding how players perceive and/or engage with the game. While some metrics directly measure technical performance, other metrics may relate to user experience and satisfaction. Examples of metrics for measuring user satisfaction include:
Player Retention: Player retention measures the percentage of players who continue playing the game over time. Higher retention rates indicate that players find the game engaging and enjoyable.
Player Churn Rate: Churn rate is the opposite of player retention and measures the percentage of players who stop playing the game over a specific period. A high churn rate may indicate issues with user satisfaction or game design.
Player Feedback and Reviews: Analyzing player feedback, reviews, and ratings provides valuable insights into user satisfaction. Positive feedback and high ratings generally indicate satisfied players, while negative feedback may highlight areas for improvement.
Net Promoter Score (NPS): NPS measures the likelihood of players to recommend the game to others. Players are asked to rate their likelihood of recommending the game on a scale of 0 to 10. Higher NPS scores indicate higher levels of user satisfaction and advocacy.
User Engagement Metrics: Metrics such as session length, frequency of gameplay sessions, and time spent in the game provide insights into user engagement and satisfaction. Longer play sessions and higher frequency of gameplay sessions suggest that players are enjoying the game.
Player Progression and Achievements: Tracking player progression, achievements unlocked, and milestones reached can indicate how engaged and satisfied players are with the game's content and mechanics.
Social Interactions: Monitoring social interactions within the game, such as player interactions, guild memberships, and in-game communication, can provide insights into how players are engaging with the community and multiplayer aspects of the game.
In-Game Surveys and Polls: Conducting in-game surveys or polls allows developers to gather direct feedback from players about their satisfaction levels, preferences, and suggestions for improvement.
Time to Fun: Time to fun measures how quickly players experience enjoyment or satisfaction when starting the game. A shorter time to fun indicates that players are quickly engaged and immersed in the gameplay experience.
Feature Usage: Analyzing which game features are most frequently used by players can help identify popular and engaging aspects of the game, as well as areas that may need improvement or further development.
Customer Support Tickets: Monitoring the volume and nature of customer support tickets can provide insights into player satisfaction and help identify common issues or pain points experienced by players.
Community Engagement: Assessing the level of community engagement, such as forum activity, social media interactions, and fan-created content, can indicate the strength of the game's community and player satisfaction.

Alternatively or additionally, the metric(s) may be for measuring a user achievement requirement. The user achievement requirement may denote goals and/or milestones for the player to accomplish within the game running on the new gaming engine. The new gaming engine may be designed to support and/or designed for optimal performance of the game. The user achievement requirement include, for example, a progression rate requirement defining a rate at which the player needs to advance through the game to achieve a target objective, and/or a return-to-player requirement defining a gain that the player is predicted to receive while playing the game.

Optionally, the analysis of the metrics associated with the gaming engine includes predicting a target set of configuration parameters. The prediction may be such that when one or more aspects of playing the game are modified according to the target set of configuration parameters, the target set of configuration parameters is predicted to improve the metric(s). For example, the target set of configuration parameters is predicted to result in the player meeting the user achievement requirement as measured by the metric(s).

The target set of configuration parameters may include a combination of a first type of configuration parameters and a second type of configuration parameters. The first type of configuration parameters may be associated with setting an effort level predicted to be tolerated by the player. The second type of configuration parameters may be associated with setting a reward level predicted as an incentive by the player. The target set of configuration parameters may be provided for configuring the new gaming engine, such as for obtaining the prediction of the player meeting the user achievement requirement as measured by the metric(s).

The prediction may be performed by a simulation engine that simulates implementation of a modified aspect(s) on playing the game. The prediction of an effect on the metric may be determined by running the simulation engine. Alternatively or additionally, the prediction may be obtained from a ML model trained to predict an effect on one or more metric in response to an input of a modified aspect(s).

Additional exemplary details of the target set of configuration parameters are described, for example, with reference to U.S. Provisional Patent Application No. 63/623,862 “AUTOMATED COMPUTATION OF PARAMETERS FOR CONFIGURATION OF A GAME ENGINE” filed on Jan. 23, 2024. Briefly:

For the first type of configuration parameters, the effort level predicted to be tolerated by the player may refer to the amount of time, energy, and/or difficulty a player is willing to invest or endure during a game. When the effort level is too high, the player cannot tolerate the required effort, and may terminate the game and/or not play in the first place. Different players may have varying preferences when it comes to the level of challenge, complexity, and time commitment they are willing to dedicate to a game. The effort level appropriate for a game may be selected according to a target audience and/or player demographics. Some players enjoy highly challenging and complex games that demand a significant investment of time and skill, while others prefer more casual and accessible experiences that are easy to pick up and play. In another example, for the same game, children may need a lower effort level than teenagers or adults.

Optionally, the first type of configuration parameter associated with setting the effort level predicted to be tolerated by the player includes an indication of increasing a difficulty of going through a certain level. Some players may enjoy a steep learning curve and challenging gameplay, while other players may prefer a more relaxed and forgiving experience. Moreover, different players may have varying amounts of time available for gaming. Some players may prefer short gaming sessions, while other player are willing to invest hours in a single play session. Furthermore, the depth and complexity of game mechanics, systems, and narratives can vary. Some players may enjoy intricate and deep gameplay, while other players may prefer simpler, more straightforward experiences. The tolerance for repetitive tasks or gameplay loops may vary among players. Some players may enjoy the grind in a game, while other players may find it tedious.

Examples of the first type of configuration parameter include:
A parameter indicating a number of negative events and/or sprites encountered by players trying to pass the certain level. The negative events and/or sprites may be of selected types which require varying effort levels to pass. For example, a negative event may be a block which may be overcome with simple effort by the player controlling a character to jump over the block. In another example, the negative event may be a monster character which fights with the character controlled by the player, requiring more effort by the player to defeat the monster.
A parameter indicating a level of availability of different aids to players trying to pass the certain level. The different aids may be of varying aid levels. For example, the player may obtain a magic potion which paralyzes monsters, enabling little effort to user to overcome the monster. In another example, the player may obtain a sword which requires more effort by the player to fight and defeat the monster.
A parameter describing graphical settings and/or user interface settings expected to influence player performance while trying to pass the certain level. For example, a field of view (FOV) may determine how much of the game world is visible on the screen at any given time. A narrow FOV showing less of the game world may require higher effort to play the game than a wide FOV showing more of the game world. In another example, pop-up boxes and/or messages indicating hints to the player of what to do, where treasures are found, and/or warning of obstacles, may reduce the effort level, while lack of such pop-ups and/or messages may increase the effort level.

For the second type of configuration parameters, the reward type, magnitude, and/or frequency of rewards that players receive within a game as incentives for their actions or achievements may be set. The reward may be, for example, obtaining in-game items, virtual currency, cosmetic items (e.g., skins costumes), access to new levels or areas of the game, extended play time, experience points, unlockable content, social rewards (e.g., publication of the name and/or picture of the player, ranking of the player relative to other players), real financial rewards, and/or real world prizes. The magnitude or value of rewards can vary. Some rewards may be small and frequent, while others may be more significant but less common. The reward level may provide additional motivation for players to pursue the goals and/or milestones of the game for reaching the user achievement requirement, by adding another a layer of satisfaction through tangible rewards. Players may be often motivated by a regular and balanced distribution of rewards. For example, too many rewards might lead to a lack of challenge, while too few could result in frustration. The reward may be implemented as a progression system where players unlock new abilities, items, or content as they advance. Achievements can be tied to specific rewards.

The target set of configuration parameters may satisfy a target balance between the first type and the second type of configuration parameters. The target balance may represent a combination of an intermediate range of values for the first type and second type of configuration parameters that are predicted to reach the user achievement requirement. For example, not too high and not too low. The target balance may be defined by a set of rules, for example, representing non-extreme values. The target balance may be represented as a non-extreme region within a function defined by different combinations of values of the first type and second type of configuration parameters. There may be multiple different combinations of ranges of the values of the first type and the second type that are predicted to result in the player achieving the user achievement requirement. However, extreme values of the first type and second type may be unsuitable even when they are predicted to result in the player achieving the user achievement requirement. For example, a high effort level required to play the game and a high reward obtained from playing the game may predict the player reaching the user achievement requirement. However, such combination is unsustainable, since players may be discouraged and/or become overly tired from playing, and stop playing altogether. The high reward may not be sufficient to keep them playing for long. Those players that do continue playing may reach the user achievement requirement. But there may be many players that quit playing the game altogether.

The combination of the first type and the second type of configuration parameters may be found, for example, by the following exemplary process. Identify ranges of values for the first type and the second type of configuration parameters that are desired, for example, non-extreme values and/or sustainable values, and/or other approaches described herein. Find a combination of maximal values for the first type and the second type of configuration parameters within the identified ranges that meet the user achievement requirement. The combination may be found, for example, by defining a function as a combination of the first type and the second type of configuration parameters over the identified ranges. Local minimums/maximums of the function may be found within the identified ranges that meet the user achievement requirement.

Alternatively or additionally, the metric(s) associated with the new gaming engine may include one or more behavior parameters relating to in-game actions of multiple players using multiple client devices engaged in a game running on the new gaming engine. The behavior parameters may refer to in-game behavior parameters relating to in-game actions and/or achievements of the players engaged in the computer game. The behavior parameters may include, for example, engagement behavior parameters (e.g., engagement time, a churn rate, a number of new players, a retention rate, etc.), in-game action behavior parameters (e.g., progress of players in the game, skills of players, player interaction with each other and/or with features of the game, etc.), asset behavior parameters (e.g., in-game assets and/or rewards gained, lost, spent, accumulated, and/or aggregated by the players, etc.), and/or the like. The analysis may include determining a balance between a user experience of one or more of the players and one or more long-term factors of the game running on the new gaming engine. Analysis of the behavior parameters may therefore reveal, expose, and/or indicate of one or more behavioral patterns, trends, conditions, and/or the like and reward recommendations estimated to balance between the player's user experience and one or more of the long-term factors of the computer game may be therefore generated and/or computed accordingly. The balance may be determined by generating one or more reward recommendations based on the behavior parameters. The reward recommendations may be for allocating one or more rewards to at least one of the players for at least one in-game action made by the player(s). The reward recommendations may be generated and/or selected for allocating rewards, for example, assets, tokens, Experience Points (XP), clues, level advancements, in-game advantages, in-game skills, in-game characters, in-game properties, monetary value and/or the like in attempt to balance between improving a user experience of one or more of the players and one or more of the long-term factors of the computer game.

Additional details of behavior parameters and/or determining the balance and/or reward recommendations (and/or other features described herein) are described, for example, with reference to U.S. Provisional Patent Application No. 63/523,949 “CONTROLLING IN-GAME REWARDS” filed on Jun. 29, 2023, incorporated herein by reference in its entirety.

At 208, one or more aspects of playing a game with the new gaming engine may be modified via the GSI. The aspects may be modified by the service engine accessing the new gaming engine hosted by the gaming services platform via the GSI of the gaming services platform. The modification may be computed based on the analysis (described with reference to 206), for improving the analyzed metric(s). Improving the metrics of the new gaming engine may lead, for example, to a smoother and/or more enjoyable player experience.

Examples of aspects of playing the game with the new gaming engine predicted to improve one or more metrics of the gaming engine (e.g., metrics as described with reference to 206) include:
Frame Rate Optimization: Ensuring smooth gameplay by maintaining a consistent and high frame rate, by involving optimizing rendering techniques, reducing unnecessary computations, and utilizing hardware efficiently.
Load Time Reduction: Minimizing loading times between levels or scenes to enhance player engagement. Techniques such as asset streaming, level-of-detail systems, and asynchronous loading can help achieve this.
Memory Management: Efficiently managing memory usage to prevent memory leaks and minimize the game's memory footprint. This can involve optimizing asset compression, implementing resource pooling, and utilizing memory profiling tools.
Input Responsiveness: Ensuring that player inputs are responsive and translate smoothly into actions within the game. This may require optimizing input handling routines and reducing input lag.
Collision Detection and Physics Simulation: Optimizing collision detection algorithms and physics simulations to accurately simulate interactions between game objects while maintaining performance. This may involve implementing spatial partitioning techniques, utilizing physics middleware, and tweaking simulation parameters.
Network Performance: Enhancing the performance and stability of multiplayer games by optimizing network code, minimizing latency, and reducing bandwidth usage. Techniques such as client-side prediction, interpolation, and lag compensation may improve the player experience in online environments.
Scalability and Cross-Platform Compatibility: Designing the gaming engine to scale across different hardware configurations and platforms, ensuring consistent performance and compatibility across a variety of devices. This involves optimizing rendering pipelines, supporting multiple graphics APIs, and utilizing platform-specific optimizations.
Analytics Integration: Integrating analytics tools to gather data on player behavior, performance metrics, and hardware configurations. Analyzing this data can provide insights for further optimization and refinement of the gaming engine.
UI/UX Optimization: Designing intuitive user interfaces and optimizing UI rendering performance to enhance the overall user experience. This includes minimizing UI overhead, optimizing layout algorithms, and ensuring responsiveness across different screen resolutions and aspect ratios.
Content Streaming and Prefetching: Implementing techniques such as content streaming and prefetching to dynamically load game assets in the background, reducing load times and improving overall performance. This can involve implementing a resource management system to prioritize asset loading based on player proximity or relevance to the current gameplay.

Optionally, when the analysis is for determining the balance between the user experience of one or more of the players and one or more long-term factors of the game running on the new gaming engine (e.g., as described with reference to 206), the modification of one or more aspects may include causing the gaming engine to adjust a graphic user interface (GUI) of the client device of at least one of the players to reflect the allocated reward(s).

The following is an exemplary process for analyzing one or more metrics and/or for modifying one or more aspects of playing a game with the new gaming engine via the GSI, for improving the analyzed metric(s): A candidate gaming scenario to be implemented in the new gaming engine and in conjunction with users interacting with the gaming engine implementing the candidate gaming scenario, is accessed. Examples of candidate gaming scenarios include: replacement of an existing reward calculation with an adapted reward calculation for allocation of rewards, a time challenge scenario, and an in-game objective scenario. The candidate gaming scenario may be implemented within the game running on the new gaming engine. The candidate gaming scenario may be associated with one or more desired outcome of users interacting with the gaming engine implementing the candidate gaming scenario. A sub-set of the users interacting with the new gaming engine (optionally interacting with the game running on the new gaming engine) is identified. The sub-set of user is identified for analyzing the candidate gaming scenario implemented by the new gaming engine (optionally implemented by the game run by the new gaming engine). The candidate gaming scenario is virtually implemented by the new gaming engine (optionally by the game run by the new gaming engine) for interaction by the users as if the candidate gaming scenario is not virtually implemented. The users are unaware of the virtual implementation during their interaction with the new gaming engine. Data on the sub-set of users is collected. The data may be collected via the GSI of the gaming services platform, optionally the sending the collected data to the service engine via the GSI. The data is collected for the sub-set of users identified in conjunction with the users interacting with the new gaming engine virtually implementing the candidate gaming scenario. One or more game related results predicted to occur when the candidate gaming engine is explicitly implemented by the new gaming engine are computed. The game related results are computed using the data collected for the virtually implemented candidate gaming engine scenario. Examples of game related results include: amount of rewards users have collected using the virtually implemented reward allocation, whether users met or did not meet a time challenge, and the like. The candidate gaming scenario may be explicitly implemented in the new gaming engine for interaction by the users in response to the game related scenario(s) meeting a target.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant gaming engines will be developed and the scope of the term gaming engine is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method for adding a new gaming engine to a gaming services platform, comprising:
identifying the new gaming engine to add to the gaming services platform, wherein the gaming services platform includes a plurality of other gaming engines operating thereon;
initiating an integration process between the gaming services platform and the new gaming engine, the integration process including modifying at least one aspect of the new gaming engine to conform to a gaming services interface (GSI) of the gaming services platform for facilitating the integration;
analyzing at least one metric associated with the new gaming engine using the GSI; and
based on the analyzing, modifying at least one aspect of playing a game with the new gaming engine via the GSI, for improving the analyzed at least one metric.

2. The computer implemented method of claim 1, wherein the plurality of other gaming engines are designed for supporting and/or for optimal performance of different types of games, and the new gaming engine is identified according to being designed for supporting and/or being designed for optimal performance of a type of game not currently supported and/or not currently optimized for execution by any of the plurality of other gaming engines hosted by the gaming services platform.

3. The computer implemented method of claim 2, wherein the different type of games include one or more of: 2D versus 3D, single player versus multi-player, fast graphic rendition, and type of client terminal on which game is being played.

4. The computer implemented method of claim 2, wherein the at least one metric is for measuring the performance of and/or user satisfaction in conjunction with, the new gaming engine running the type of game not currently supported and/or not currently optimized for execution by any of the plurality of other gaming engines hosted by the gaming services platform.

5. The computer implemented method of claim 1, wherein the plurality of other gaming engines and the new gaming engine added to the gaming services platform are operated and/or accessed via a common GSI of the gaming services platform.

6. The computer implemented method of claim 1, wherein each one of the plurality of other gaming engines and the new gaming engine added to the gaming services platform is associated with a respective instance of the GSI.

7. The computer implemented method of claim 6, wherein the plurality of other gaming engines and the new gaming engine are hosted by an external computing environment that is different than a computing platform hosting the gaming services platform.

8. The computer implemented method of claim 6, wherein each one of the plurality of other gaming engines and the new gaming engine uses its respective instance of the GSI for communicating with a service engine, for being accessed and/or controlled and/or managed by the service engine.

9. The computer implemented method of claim 1, wherein the integration process comprises:
obtaining a source code operative to implement the new gaming engine;
applying a machine learning (ML) model to the source code, wherein the ML model is pre-trained to identify at least one region in the source code to be modified to conform to the GSI; and
receiving, from the ML model, at least a suggestion indicating modification of the at least one region of the source code to conform to the GSI.

10. The computer implemented method of claim 9, wherein applying comprises applying the ML model to the source code in combination with at least one aspect of the new gaming engine for modification to conform to the GSI, wherein the suggestion indicates modification of the at least one aspect of the source code of the new gaming engine to conform to the GSI.

11. The computer implemented method of claim 9, wherein the at least the suggestion comprises automatically modifying the at least one region of the source code and compiling the source code including the modifications to create an executable version of the new gaming engine for adding to the gaming services platform.

12. The computer implemented method of claim 9, wherein the ML model is trained on a training dataset of a plurality of records, wherein a record includes a sample source code of a sample gaming engine and sample at least one aspect, and a ground truth indicating at least one recommendation for adapting the at least one aspect of the sample source code to conform to the GSI.

13. The computer implemented method of claim 1, wherein the at least one aspect of the new gaming engine is modified to conform to the GSI.

14. The computer implemented method of claim 13, wherein the at least one aspect being modified to conform to the GSI is selected from: input handling from different user interface devices supported by the GSI, meeting rendering standard supported by the GSI, meeting a physics simulation supported by the GSI, meeting audio capabilities supported by the GSI, enabling multiplayer features supported by the GSI, meeting user interface (UI) features supported by the GSI, script supported by the GSI, meeting resources supported by the GSI, performance requirements supported by the GSI, and compatibility with different end user devices supported by the GSI, and providing a data interface for relaying gaming data information from the new gaming engine for analysis by the service engine via the GSI of the gaming services platform.

15. The computer implemented method of claim 1, wherein analyzing comprises predicting a target set of configuration parameters, that when the at least one aspect of playing the game is modified to the target set of configuration parameters, the target set of configuration parameters improves the at least one metric.

16. The computer implemented method of claim 15, wherein the predicting is performed by a simulation engine for simulating implementation of a modified at least one aspect on playing the game for predicting an effect on the at least one metric.

17. The computer implemented method of claim 15, herein the predicting is performed by a ML model trained to predict an effect on at least one metric in response to an input of a modified at least one aspect.

18. The computer implemented method of claim 15, wherein the at least one metric is for measuring a user achievement requirement denoting goals and/or milestones for the player to accomplish within a type of game for which the new gaming engine is designed to support and/or designed for optimal performance.

19. The computer implemented method of claim 15, wherein the target set of configuration parameters comprises a combination of a first type of configuration parameters and a second type of configuration parameters, the first type of configuration parameters being associated with setting an effort level predicted to be tolerated by the player, and the second type of configuration parameters associated with setting a reward level predicted as an incentive by the player.

20. The computer implemented method of claim 1, wherein the new gaming engine to be added to the gaming service platform is identified according to ability to run a candidate gaming scenario meeting a target, wherein the candidate gaming scenario is associated with at least one desired outcome of users interacting with the gaming engine implementing the candidate gaming scenario.

21. The computer implemented method of claim 20, further comprising:
identifying, in the new gaming engine, a sub-set of the users interacting with the gaming engine for analyzing the candidate gaming scenario implemented by the new gaming engine;
virtually implementing the candidate gaming scenario by the new gaming engine for interaction by the users as if the candidate gaming scenario is not virtually implemented;
collecting data on the sub-set of users identified, in conjunction with the users interacting with the gaming engine virtually implementing the candidate gaming scenario;
computing at least one game related result predicted to occur when the new gaming scenario is explicitly implemented by the candidate gaming engine using the data collected for the virtually implemented candidate gaming engine scenario; and
in response to the at least one game related scenario meeting a target, identifying the new gaming engine to be added to the gaming services platform for running the candidate gaming scenario for interaction by the users.

22. The computer implemented method of claim 1, wherein analyzing at least one metric and modifying at least one aspect of playing the game with the new gaming engine via the GSI, for improving the analyzed at least one metric, comprises:
accessing a candidate gaming scenario to be implemented in the new gaming engine and in conjunction with users interacting with the gaming engine implementing the candidate gaming scenario, wherein the candidate gaming scenario is associated with at least one desired outcome of users interacting with the gaming engine implementing the candidate gaming scenario;
identifying a sub-set of the users interacting with the new gaming engine for analyzing the candidate gaming scenario implemented by the new gaming engine;
virtually implementing the candidate gaming scenario by the new gaming engine for interaction by the users as if the candidate gaming scenario is not virtually implemented;
collecting data on the sub-set of users identified in conjunction with the users interacting with the new gaming engine virtually implementing the candidate gaming scenario;
computing at least one game related result predicted to occur when the candidate gaming engine is explicitly implemented by the new gaming engine using the data collected for the virtually implemented candidate gaming engine scenario; and
wherein modifying at least one aspect comprises:
in response to the at least one game related scenario meeting a target, explicitly implementing the candidate gaming scenario in the new gaming engine for interaction by the users.

23. The computer implemented method of claim 1, wherein the at least one metric associated with the new gaming engine comprises a plurality of behavior parameters relating to in-game actions of a plurality of players using a plurality of client devices engaged in a game running on the new gaming engine,
wherein analyzing comprises balancing between a user experience of at least one of the plurality of players and at least one long-term factor of the game running on the new gaming engine by generating, based on the plurality of behavior parameters, at least one reward recommendation for allocating at least one reward to at least one of the plurality of players for at least one in-game action made by the at least one player,
wherein modifying at least one aspect comprises causing the gaming engine to adjust a graphic user interface (GUI) of the client device of at least one of the plurality of players to reflect the at least one allocated reward.

24. A system for adding a new gaming engine to a gaming services platform, comprising:
at least one processor executing a code for:
identifying the new gaming engine to add to the gaming services platform, wherein the gaming services platform includes a plurality of other gaming engines operating thereon;
initiating an integration process between the gaming services platform and the new gaming engine, the integration process including modifying at least one aspect of the new gaming engine to conform to a gaming services interface (GSI) of the gaming services platform for facilitating the integration;
analyzing at least one metric associated with the new gaming engine using the GSI; and
based on the analyzing, modifying at least one aspect of playing a game with the new gaming engine via the GSI, for improving the analyzed at least one metric.

25. A non-transitory medium storing program instructions for adding a new gaming engine to a gaming services platform, which when executed by at least one processor, cause the at least one processor to:
identify the new gaming engine to add to the gaming services platform, wherein the gaming services platform includes a plurality of other gaming engines operating thereon;
initiate an integration process between the gaming services platform and the new gaming engine, the integration process including modifying at least one aspect of the new gaming engine to conform to a gaming services interface (GSI) of the gaming services platform for facilitating the integration;
analyze at least one metric associated with the new gaming engine using the GSI; and
based on the analyzing, modify at least one aspect of playing a game with the new gaming engine via the GSI, for improving the analyzed at least one metric.
